(19) United States
(12) Patent Application Publication
(10) Pub. No.: US 2008/0234161 A1
(43) Pub. Date: Sep. 25, 2008

(54) Solid Detergent Bar

(75) Inventors: Shreedhar Iyer, Singapore (SG); Venkateswara Kumar Vedantam, Paramus, NJ (US); Koh Ai Teng, Singapore (SG)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 11/912,996

(22) PCT Filed: May 24, 2006
(86) PCT No.: PCT/CH06/00277

§ 371 Date: Jun. 4, 2008

(30) Foreign Application Priority Data
Jun. 2, 2005 (GB) 0511235.4

(51) Int. Cl. A61Q 19/10

(52) U.S. Cl. 510/141

(57) ABSTRACT

A method of preparing benefit agent-containing bar detergent, comprising plodding noodles of benefit agent-containing detergent material into bars, the noodles being characterised that at from 5-95% by weight of the noodles are coated with a film of a water-soluble polymeric material that softens on exposure to water and hardens again when that exposure is removed, the film being benefit agent-permeable when soft and benefit agent-impermeable when hard. The method is particularly effective at disguising the tendency to rancidity of soaps based on natural oils and fats, by the incorporation of fragrance as benefit agent.

This invention relates to solid detergent bars and to methods of making them.

Solid detergent bars, such as bar soap, are widely used, and in many parts of the world they are the only commonly-available form of detergent for washing clothing or people. Fragrance is a common ingredient in such bars; indeed in some cases it could be considered essential, as fragrance may be needed to offset the increasing rancidity with time of some naturally-derived detergent materials, such as natural oils and saponified fats, still in common use in some parts of the world. Fragrance may be incorporated into detergent materials by a number of means, for example by simply adding it to the detergent material prior to the formation of the detergent material into bars. The process of making conventional fragranced bar detergent is to make the detergent material itself, add fragrance thereto and process the resulting material into so-called “noodles”, small particles, typically spherical or cylindrical with dimensions of the order of from 0.1-3 cm., that can then be processed into bars by a process called “plodding”, or compacting the noodles into bars under pressure.

The problem with this conventional approach is that there is an initial high level of fragrance emission, which level drops off dramatically with time. Unfortunately, this generally means that the peak emission of fragrance takes place before the onset of rancidity and does not therefore adequately compensate for this.

One obvious answer is the use of encapsulated fragrance. There are many ways of achieving this, such as precipitating an encapsulating film around suspended droplets of liquid fragrance, or by adsorbing fragrance on to a solid particulate absorbent, such as bentonite. The methods of performing these encapsulations are well known. However, the resulting encapsulated products are often unable to withstand the shearing forces generated during plodding and the result is often that a substantial proportion of the fragrance is unavoidably prematurely released. In addition, these technologies can add significantly to the price of the final bar.

Although the foregoing discussion has been centred on fragrance, which is of particular significance, there are other desirable materials that have beneficial properties and can be and are usefully contained in and advantageously released from solid detergent bars in a controlled manner. Examples of such materials include skin emollients, skin lightening/whitening agents, insect repellents, whitening agents, UV absorbers. These shall hereinafter be referred to as “benefit agents”

It has now been found that a particular method of making benefit agent-containing bar detergent can give bars that have a surprisingly long duration benefit agent release. The invention therefore provides a method of preparing benefit agent-containing bar detergent, comprising plodding noodles of benefit agent-containing detergent material into bars, the noodles being characterised that at from 5-95% by weight of the noodles are coated with a film of a water-soluble polymeric material that softens on exposure to water and hardens again when that exposure is removed, the film being benefit agent-permeable when soft and benefit agent-impermeable when hard.

The invention additionally comprises benefit agent-containing bar detergent prepared by a method as hereinabove described.

The surprising feature of this invention is that, when the noodles are so coated, the release of benefit agent is not only more regular but also much more long-lasting. In the case of fragrance benefit agent, any malodour produced by detergent materials, such as natural oils and saponified natural fats, that start to go rancid is disguised for a substantial time, and fragrance emission may even last for the entire lifetime of the bar. In addition, unlike many kinds of fragrance encapsulation, this fragrance release is unaffected by plodding. Moreover, the lack of need to encapsulate reduces costs significantly.

The detergent material useful in this invention may be any detergent material that can be formed into a solid bar. It may be, for example, a saponified natural fat, or it may be a synthetic material, such as one or more surfactants. It is naturally possible and permissible to have a mixture of different types of detergent material. The advantages of the invention are noticeable in all detergent materials, but they are especially so in saponified natural (animal and vegetable) fats, which have the highest tendency to rancidity. Although the method of this invention can be used for any naturally-derived detergent material, a detergent material for which the invention works particularly well comprises a mixture of 15-45% by weight of at least one of coconut oil and palm kernel oil and from 5-85% palm stearin fatty acid.

The complete range of synthetic detergent materials can be used in this invention. Examples include anionic surfactants such as sodium lauryl ether sulphate, sodium cocoyl isethionate, sodium lauryl sulphate, alpha olefin sulphonates, linear alkyl benzene sulphonates, amphoteric surfactants such as cocoamidopropyl betaines, sulphobetaine; nonionic surfactants such as alkyl phenol ethylene oxide condensates, sugar amide, and cationic surfactants such as quaternary ammonium compounds.

The benefit agent may be any suitable substance whose presence is desired in the detergent bar for any specific purpose. As hereinabove mentioned, fragrance is of particular interest, but the invention is not limited to that, and any other substance whose controlled release is desired may be employed. Typical examples include skin lightening/whitening agents, emollients, moisturising agents, insect repellents, fluorescence agents, vitamins and antibacterial agents. The proportions to be used will vary widely, depending on the particular benefit agent and the nature of the release sought, but typical proportions for non-fragrance benefit agents are from 0.1-10% by weight of the total detergent bar.

In the case of fragrance, any desired fragrance may be used in this invention. The fragrance may be used in any form. For example, if desired, it may be used in encapsulated form, using any encapsulating technology known to the art. However, one of the major advantages of this invention is that a prolonged fragrance release can be achieved using unencapsulated liquid fragrance added directly to the detergent. This gives substantial cost savings and is the preferred embodiment for fragrance.

Fragrance is generally a mixture of individual compounds, sometimes a considerable number of such compounds. The fragrance in both coated and uncoated noodles may be the same or different. In one preferred embodiment, a fragrance is separated into high volatility and low volatility fractions, respectively known as “top notes” and “bottom notes”, and each is contained in different noodles, the top note noodles being coated with the polymeric substance. This delays the emission of the more volatile top notes and makes them last longer than would usually be the case.

The quantity of fragrance within the two different types may also vary. The proportion of fragrance present in the noodles lies typically in the range of from 0.01-10%, preferably from 1-5% by weight.

The essential feature of the invention is the coating of a proportion of the noodles with a film of a water-soluble polymeric material as hereinabove described. The proportion of coated noodles may vary between 5 and 95% by weight of the total noodle content of the detergent bar. Preferably the proportion of coated noodles is from 25% to 75%, more preferably 50% of each by weight.

The polymer should have the following characteristics:
it should be water soluble, and an aqueous solution should have a viscosity of from 10-150 centipoise (Brookfield spindle No. 21 at 10 rpm and 23° C.);
it should have the ability to form a solid film on detergent material.

The extent of water solubility should be from 0.1-25% w/v, and the viscosity should be as described. The ability to form a solid film that is benefit agent-impermeable when hard and benefit agent-permeable when soft is something that is highly dependent on both agent and polymer, and which cannot be predicted. However, it can readily be determined by simple experimentation. Typical examples of polymeric materials that work in this invention include polyvinyl alcohols, polyethylene glycols, water-soluble acrylates, some natural gums (such as xanthan), polyvinyl pyrrolidone, carrageenan and some cellulosic materials (such as CMC).

The preferred polymeric materials are polyvinyl alcohol and polyethylene glycol. With respect to polyvinyl alcohol, the best materials are grades where the range of extent of hydrolysis is between 85-99%, and the molecular weight range lies between 13000-23000. Typical examples of useful commercial materials may be found in the CELVOL™ range of Celanese, specific examples including CELVOL™ 103, 305, 107, 502, 504, 203 and 205. The preferred polyethylene glycols are those with weight-average molecular weight of at least 6,000, preferably 8,000-10,000. Materials of higher molecular weight can be used, but very high molecular weights can result in solutions that are too viscous. Typical examples of useful commercial materials may be found in the Pluriol™ E-grade range of BASF, specific examples including Pluriol™ E 1500, E 1505, E 3400, E 3405, E 4000, E 4005, E 6000, E 6005 and E 8000.

Provided there is applied sufficient polymeric material essentially to coat the individual noodles completely, the quantity of polymer used is not critical. A typical proportion is from 0.5-20%, more preferably from 5-10%, more preferably from 5-6% by weight of polymeric material of the total composition of the detergent bar.

In addition to detergent material and benefit agent, other materials commonly used in such bars may be used in art-recognised quantities for their normal functions. Typical examples include pigments and other colouring matters, fillers, abrasives, bactericides, free fatty acid, preservative, antioxidants and chelating agents

The process of making a detergent bar is essentially entirely conventional, in that noodles of detergent material containing the desired benefit agent are first prepared and the noodles then plodded into bars. Where the present invention differs is that a desired portion of noodles is coated with an aqueous solution, emulsion or dispersion of the polymeric material by conventional means (for example, by spraying it on to the noodles in a ribbon blender). This is allowed to dry, and the coated noodles are then mixed with non-coated noodles and plodded into bars, followed by stamping.

As mentioned hereinabove, the detergent bars made according to this invention has a surprisingly long release of benefit agent. This is especially noticeable with fragrances.

The invention is now further described with reference to the following non-limiting examples.

(a) Procedure for Manufacturing a Soap

A number of soaps are made by known procedures as hereinunder further described. In each case, two types of soap noodles are used, one type containing the heavy middle or bottom fragrance notes, the other the fresh top notes. The top note-containing soap noodles are coated with polymeric solution (a 20% (wt) aqueous solution of polyvinyl alcohol (the material used is Celvol™ 103)) by spraying the polymeric solution on to the fragranced soap noodles in a ribbon blender. This mix of top note-containing soap noodles is then dried under normal conditions overnight in order for the polymeric film to develop on the soap noodles. Olfactive impact of the coated soap noodles is less than that of the uncoated soap noodles, indicating the presence of a coating. The coated and uncoated soap noodles are then mixed together and then plodded into soap bars, followed by stamping. The fresh soap has a mixed note immediately after plodding.

Four samples each of a palm oil-based soap, a tallow-based soap and a synthetic detergent (“Syndet”) bar are made.
1) Soap I, 50:50 coated:uncoated noodles, the coated containing 1.0% by weight top note fragrance and the uncoated containing 2% middle and base note based fragrance.
2) Soap II, 25:75 coated and uncoated noodles, the coated containing 1.0% by weight top note fragrance and the uncoated containing 2% middle and base note based fragrance.
3) Soap III, as Soap I, but all noodles are uncoated.
4) Soap IV, as Soap II, but all noodles are uncoated.

The composition for palm oil base soap is as follows:

| Ingredients | % in formula |
|---|---|
| Sodium palmate/Sodium palm kernelate* | 97.00 |
| Titanium dioxide | 0.30 |
| Na₄EDTA complexing agent** | 0.10 |
| (40% aqueous solution) | |
| Glycerin | 1.00 |
| Water | 1.60 |

*Prisavon 9240 ™ ex Uniqema
**Trilon ™ B ex BASF

The composition for tallow oil base soap is as follows:

| Ingredients | % in formula |
|---|---|
| Sodium Tallowate/Sodium palm kernelate* | 97.00 |
| Titanium dioxide | 0.30 |
| Na₄EDTA complexing agent** | 0.10 |
| (40% aqueous solution) | |
| Glycerin | 1.00 |
| Water | 1.60 |

*Prisavon 9250 ™ ex Uniqema
**Trilon ™ B ex BASF

The composition of the Syndet bar is as follows:

| Ingredients | % in formula |
|---|---|
| Sodium Cocoyl Isethionate* | 68.00 |
| Stearic acid | 25.00 |
| Titanium dioxide | 0.50 |
| Na₄EDTA complexing agent** | 0.10 |
| (40% aqueous solution) | |
| Glycerin | 3.00 |
| Silicon fluid | 0.50 |
| Water | 3.00 |

*Hostapon ™ SCI ex Clariant
**Trilon ™ B ex BASF

(b) Olfactive Evaluation of the Soap

After maceration (by wrapping in aluminium foil and storing for 3 weeks at 25° C.), the soap is washed under running tap water. In the first wash itself, there is a strong burst of the top-note, which can be perceived both from the soap and on the palm. The effect is more pronounced after subsequent washes, i.e., when the soap is washed immediately. The top-note becomes predominant both in the soap bar and on the palms (foam). The soap is placed in a soap dish after use and left for drying. At this stage the soap bar has the predominant top note. After 2 hours of drying the soap bar has reverted back to predominant middle and base notes. Thus, it is evident that the polymeric film has reformed and thus, protected the more volatile top note.

On washing with this dried soap, the top note is again released immediately in the first wash, becoming more predominant on subsequent washes. Thus, it is evident that the top note is protected by the polymeric film in the dry stage and released only when the soap is being used. This property of water activated fragrance release and protection of the sensitive top note in the dry stage is observed in the soap until the soap has been used up. Thus, on one hand the invention deliver s the unique water activated benefit to the soap and on the other hand also ensures a longer lasting fragrance in the soap bar.

The products are tested by a panel.

The panellists are asked to comment about the performance of the soaps, both at dry stage and in use. Thus, the following two panel tests are carried out—
1) First they are asked to rate the performance of the soaps at neat stage and after 2 hours of the first use. This is to prove the fact that the top notes are very much subdued in neat stage and at dry stage after use.
2) They are then asked to comment on the top note performance after every 3 days of use by rating the top note impact from the soaps. This is to prove that the top notes are released during the in-use stage only.

The soaps are assessed on a scale of from 1-5, as follows:
1—No top note perceived on washing
2—Slight top note perceived on washing
3—Medium top note perceived on washing
4—Strong top note perceived on washing
5—Very strong top note perceived on washing

1) Performance at Dry Stage—

The panellists were asked to rate the top note performance in neat stage and after 2 hours of use

| | |
|---|---|
| Neat stage | After 2 hours of use |

A) palm oil-based soap bar

| | | |
|---|---|---|
| Soap I | 3.5 | 3.3 |
| Soap II | 3.0 | 2.9 |
| Soap III | 5 | 4.7 |
| Soap IV | 5 | 4.5 |

B) tallow oil-based soap bar

| | | |
|---|---|---|
| Soap I | 3.2 | 3.0 |
| Soap II | 2.9 | 2.6 |
| Soap III | 4.5 | 4.1 |
| Soap IV | 4.3 | 4.0 |

C) Syndet bar

| | | |
|---|---|---|
| Soap I | 3.2 | 3.0 |
| Soap II | 3.0 | 2.7 |
| Soap III | 4.5 | 4.2 |
| Soap IV | 4.2 | 4.0 |

Thus, from the above, it is evident that, for the soaps containing the coated noodles, the top notes are not strongly perceived in the dry stage.

2) In-Use Performance—

The panellists are asked to rate the top note performance in-use

The average scores of the panel testing are given below—

| | | | | |
|---|---|---|---|---|
| Day 1 | Day 3 | Day 6 | Day 9 | Day 12 |

A) palm oil-based soap bar

| | | | | | |
|---|---|---|---|---|---|
| Soap I | 5 | 4.9 | 4.1 | 3.1 | 1.9 |
| Soap II | 5 | 4.8 | 3.9 | 2.7 | 1.5 |
| Soap III | 5 | 4.9 | 3.5 | 2.1 | 1.0 |
| Soap IV | 5 | 4.7 | 3.4 | 2.0 | 1.0 |

B) tallow oil-based soap bar

| | | | | | |
|---|---|---|---|---|---|
| Soap I | 4.0 | 3.5 | 3.0 | 2.6 | 1.8 |
| Soap II | 4.0 | 3.2 | 2.7 | 2.3 | 1.5 |
| Soap III | 4.1 | 3.4 | 2.5 | 2.0 | 1.0 |
| Soap IV | 4.0 | 3.1 | 2.3 | 1.7 | 1.0 |

C) Syndet bar

| | | | | | |
|---|---|---|---|---|---|
| Soap I | 3.8 | 3.3 | 3.1 | 2.7 | 1.9 |
| Soap II | 3.9 | 3.1 | 2.5 | 2.1 | 1.4 |
| Soap III | 4.0 | 3.4 | 2.6 | 1.9 | 1.0 |
| Soap IV | 4.1 | 3.1 | 2.2 | 1.6 | 1.0 |

Thus, as seen from the results above, Soap I and Soap II (with the protected polymer coating) protect and preserve the top notes when the soaps are not being used, and release it only when the soaps are being washed with water.

1. A method of preparing benefit agent-containing bar detergent, comprising plodding noodles of benefit agent-containing detergent material into bars, the noodles being characterised that at from 5-95% by weight of the noodles are coated with a film of a water-soluble polymeric material that softens on exposure to water and hardens again when that exposure is removed, the film being benefit agent-permeable when soft and benefit agent-impermeable when hard.

2. A method according to claim 2, in which the polymeric material has, as an aqueous solution, a viscosity of from 10-150 centipoise (Brookfield spindle No. 21 at 10 rpm and 23° C.), and also the ability to form a solid film on detergent material.

3. A method according to claim 1, in which the benefit agent is a fragrance.

4. A method according to claim 1, in which the polymeric material is selected from polyvinyl alcohol and polyethylene glycol.

5. A method according to claim 1, in which the a detergent material comprises a mixture of 15-45% by weight of at least one of coconut oil and palm kernel oil and from 5-85% palm stearin fatty acid.

6. A method according to claim 3, in which the proportion of fragrance present in the noodles lies typically in the range of from 0.01-10%, preferably from 1-5% by weight.

7. A method according to claim 3, in which the fragrance is separated into high volatility “top notes” and low volatility “bottom notes” fractions, and each is contained in different noodles, the top note noodles being coated with the polymeric substance.

8. A method according to claim 1, in which the proportion of coated noodles is from 25% to 75%, more preferably 50% of each by weight.

9. A benefit agent-containing bar detergent obtainable by a method according to claim 1.
